(19) United States
(12) Patent Application Publication
(10) Pub. No.: US 2004/0260606 A1
(43) Pub. Date: Dec. 23, 2004

(54) Method of generating revenue from the right to display advertising information on or adjacent to a public right-of-way

(76) Inventor: Bradley Emalfarb, Riverwoods, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/601,390

(22) Filed: Jun. 23, 2003

(51) Int. Cl. G06F 17/60

(52) U.S. Cl. 705/14

(57) ABSTRACT

A method of generating revenue from the right to display advertising information on, or adjacent to, a public right-of-way. The method includes the steps of: providing a support on or adjacent to a public right-of-way including at least one lane for vehicle traffic to move in a first direction and a second lane spaced to a side of the one lane for vehicle traffic to move in a second direction oppositely to the first direction; providing information pertaining to the public right-of-way on the support in a manner that the information is viewable by an occupant of a vehicle in the one lane moving in a first direction and facing generally in the first direction; providing advertising information unrelated to the public right-of-way on a support so that the advertising information is viewable by an occupant of a vehicle moving in the second direction in one of the lanes and facing in the second direction; and charging a fee to an entity to allow the advertising information to be maintained on the support by the entity.

### BACKGROUND OF THE INVENTION

1. Field of the Invention

This invention relates to advertising signage and, more particularly, the display of advertising signage at, or adjacent to, a public right-of-way.

2. Background Art

Advertising space, viewable from public right-of-ways, is at a premium, particularly in high traffic areas which are heavily populated. Roadsides are peppered with billboards, many of which are lighted to be at night. Some carry information on two oppositely facing surfaces to be visible to persons travelling in opposite directions.

These billboards present a number of problems. First of all, these billboards are often made large and elevated to be highly visible. However, while this may make these signs effective from an advertising standpoint, it often makes them otherwise unsightly. These billboards often significantly detract from an otherwise scenic landscape. Legislators who seek to cater to tourism are caught in the balance between presenting an eye-catching view of the local landscape to tourists and allowing local businesses to promote their wares and services to these tourists.

Real estate that is in close proximity to such billboards may be devalued by reason of the presence of the billboards. This accounts for a loss in revenue at both the federal and local levels.

Further, billboards that are illegal or nonconforming to federal regulations, such as those set out in the billboard law, passed by Congress in 1965, at sites where large numbers of billboards are present, abound. In the recent past, this activity prompted the Federal Highway Administration to order states to remove tens of thousands of illegal and nonconforming billboards. This has put the states, the federal government, and the billboard owners at odds and has resulted in higher administrative and removal costs and court litigation. This highlights the need for more available advertising space which would produce revenue rather than stretch already tight budgets, thereby freeing money for more important projects such as road improvement.

Another more significant problem is that relating to safety. Billboards are commonly seen spaced from both sides of a public right-of-way. The attention of drivers may be diverted to these signs. Excessive numbers of these signs placed significant distances off of the right-of-way may cause drivers to concentrate on the signs long enough that a dangerous traffic situation may develop.

Signage painted directly on overpasses avoids significantly the problem of attention diversion for drivers. However, in most locales, overpasses are relatively sparse and thus offer relatively inadequate opportunities for advertisers.

Road signage, such as street identification, highway identification, exit identification, distance identification, and other information relating directly to the highways, is conspicuously located in highly visible areas to safely convey information to drivers with minimal diversion of attention. Some of these signs have very elaborate foundational structures and lighting. In spite of the investment that is made in some of these signs, they are essentially one-dimensional, i.e., they contain only highway information viewable from only one direction. The backs of these signs remain unused, i.e., they contain no information relating to the highway or private advertising.

### SUMMARY OF THE INVENTION

In one form, the invention is directed to a method of generating revenue from the right to display advertising information on, or adjacent to, a public right-of-way. The method includes the steps of: providing a support on or adjacent to a public right-of-way including at least one lane for vehicle traffic to move in a first direction and a second lane spaced to a side of the one lane for vehicle traffic to move in a second direction oppositely to the first direction; providing information pertaining to the public right-of-way on the support in a manner that the information is viewable by an occupant of a vehicle in the one lane moving in a first direction and facing generally in the first direction; providing advertising information unrelated to the public right-of-way on a support so that the advertising information is viewable by an occupant of a vehicle moving in the second direction in one of the lanes and facing in the second direction; and charging a fee to an entity to allow the advertising information to be maintained on the support by the entity.

The step of providing advertising information may involve providing the information on a substantial flat, first display surface facing in the first direction.

The step of providing information pertaining to the public right-of-way may involve providing information pertaining to the public right-of-way on a substantially flat, second display surface facing oppositely to the first direction.

The method may further include the step of illuminating the advertising information.

In one form, the step of providing information pertaining to the public right-of-way involves providing information pertaining to the public right-of-way on a first display surface that is on the support in an elevated position and at least partially directly over the one lane.

The step of providing the support may involve providing a cantilevered arm projecting across at least part of the one lane with the first display surface on the cantilevered arm.

The step of providing a support may involve providing first and second upright sections with one of the upright sections on side of the one lane opposite to the second lane and the other of the upright sections on the side of the second lane opposite to the one lane, with a spanning section between the first and second upright sections and extending fully across both the one and second lanes. With this configuration, the step of providing advertising information may involve providing the advertising information on the spanning section.

In one form, the step of providing a support may involve providing a support that is fully spaced sideways from both of the lanes.

In one form, the step of providing information pertaining to the right-of-way involves providing information pertaining to the right-of-way on a first display surface with a first area on the support, with the step of providing advertising information involving providing advertising information on a second display surface with a second area on the support. The first and second areas overlap both sideways and in a vertical direction.

In one form, the steps of providing information pertaining to the right-of-way and advertising information involve situating the first and second areas so that the second display surface is substantially completely obstructed by the first display surface from the perspective of an occupant of a vehicle in the one lane moving in the first direction.

In one form, the information pertaining to the right-of-way is provided on a first display system and the advertising information is provided on a second display system. The method may further include the steps of providing periodic maintenance to at least one of the support and the first display system, providing periodic maintenance to the second display system in conjunction with the periodic maintenance to the at least one of the support and the first display system, and charging a fee to the entity for the periodic maintenance to the second display system.

The method may further include the steps of changing the advertising information and charging a fee to the entity for changing the advertising information.

The invention is further directed to a method of generating revenue from the right to display advertising information on or adjacent to a public right-of-way, which method includes the steps of: providing a support on or adjacent to a public right-of-way having first and second lanes for vehicle traffic to move in one direction and third and fourth lanes to one side of the first and second lanes for vehicle traffic to move in a second direction opposite to the one direction; providing a first display system on the support and having information thereon pertaining to the public right-of-way and viewable from a first vantage point; providing a second display system on a support and having advertising information thereon that is substantially unviewable from the first vantage point and so that the information pertaining to the public right-of-way is viewable from the second vantage point; and charging a fee to an entity to allow the advertising information to be maintained on the support by the entity. The information pertaining to the public right-of-way is viewable by an occupant of a vehicle moving in the one direction in one of the first and second lanes and facing in the one direction. The advertising information is viewable by an occupant of a vehicle moving oppositely to the one direction in one of the third and fourth lanes and facing oppositely to the one direction.

In one form, there is a center median between the first and second lanes and the third and fourth lanes and the step of providing a second display system involves providing a second display system at least partially over the center median.

In one form, there is a first shoulder region to a side of the first and second lanes opposite to the one side and the step of providing the second display system involves providing the second display system at least partially directly over the first shoulder region.

In one form, the step of providing the second display system involves providing the second display system spaced to one side of the third and fourth lanes and at least partially directly over the first lane.

In one form, the step of providing the second display system involves providing the second display system so that the second display system is not directly over either of the third and fourth lanes.

The step of providing a support may involve providing a spanning section extending continuously and fully across the first, second, third, and fourth lanes.

In one form, the steps of providing first and second display systems involves providing first and second display panels, respectively having information pertaining to the right-of-way and the advertising information thereon, with the first and second display panels having substantially the same shape.

The step of providing first and second display panels may involve providing first and second display panels having substantially the same size.

The method may further include the steps of providing periodic maintenance to at least one of the support and the first display system, providing maintenance to the second display system in conjunction with the periodic maintenance to the at least one of the support and the first display system, and charging a fee to the entity for the periodic maintenance to the second display system.

The method may further include the steps of changing the advertising information and charging a fee to the entity for changing the advertising information.

### BRIEF DESCRIPTION OF THE DRAWINGS

FIG. 1 is a schematic, plan view of a portion of a public right-of-way and bordering property showing various conventional-type sign systems modified to incorporate the present invention;

FIG. 2 is an elevation view of a conventional sign system taken from one side thereof;

FIG. 3 is a view as in FIG. 2 from the opposite side thereof;

FIG. 4 is a view as in FIG. 3 with the structure modified to practice the present invention; and

FIG. 5 depicts the inventive method in block diagram form.

### DETAILED DESCRIPTION OF THE DRAWINGS

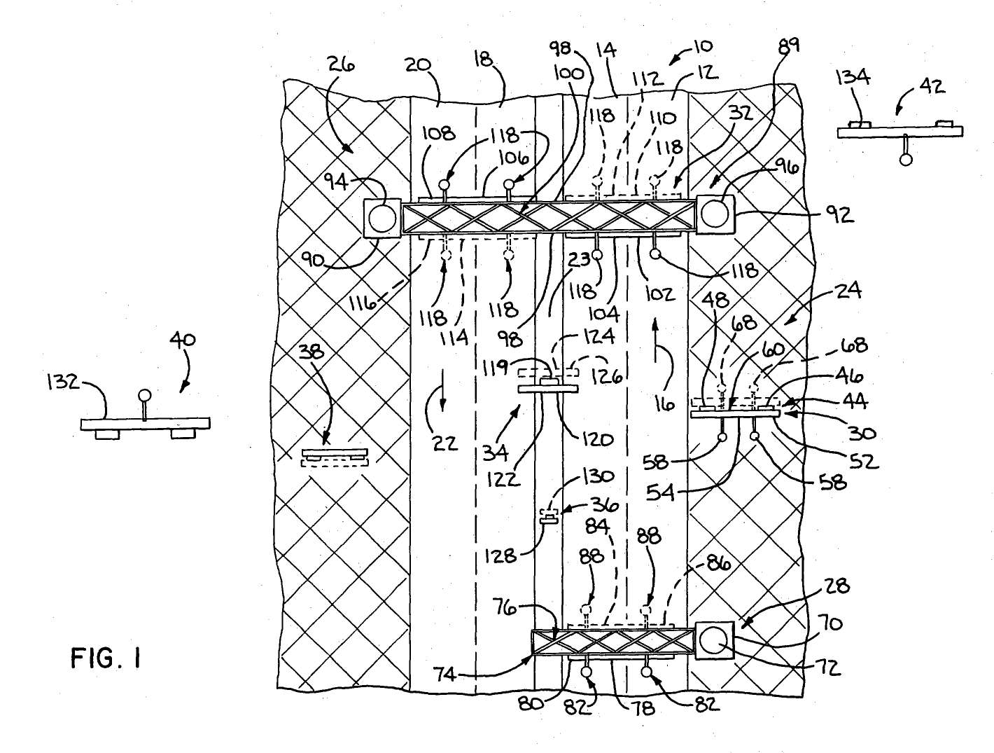

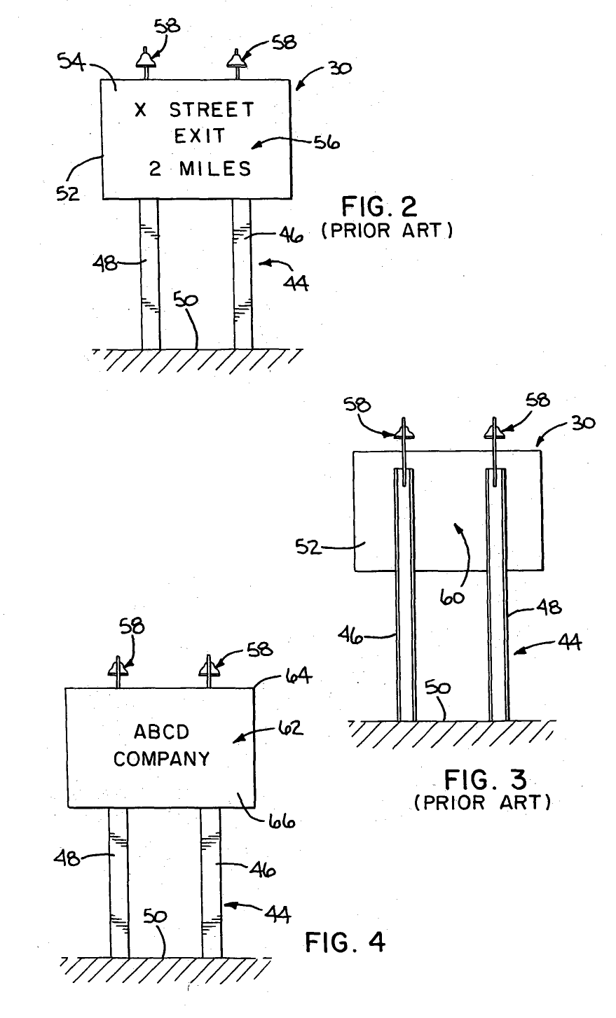

In FIG. 1, a public right-of-way is shown schematically at 10, in this case having first and second, contiguous, side-by-side lanes 12, 14 for travel of vehicles in a first direction, as indicated by the arrow 16, and third and fourth similarly configured lanes 18, 20 for travel by vehicles in a second direction, as indicated by the arrow 22, that is opposite to the first direction for traffic in the first and second lanes 12, 14. A center median 23 is formed between the lane pairs 12, 14 and 18, 20. To the side of the lane pair 12, 14, opposite that of the lane pair 18, 20, is a first shoulder region 24. To the side of the lane pair 18, 20, opposite to the lane pair 12, 14, is a separate shoulder region 26. The shoulder regions 24, 26 may be flat or sloped and may continue for distances as determined by federal or local law.

Existing sign systems, with information pertaining to the public right-of-way 10, are diverse in form and location. The sign systems are generally constructed and maintained by the federal or local authority which controls the right-of-way 10. In FIG. 1, various sign systems 28, 30, 32,34, 36, 38 are shown, together with sign systems 40, 42, which in this case are shown to be on private property spaced to the sides of the right-of-way 10.

The sign systems 30,38 have the same construction, with exemplary sign system 30 shown in detail in FIGS. 2 and 3. The sign system 30 consists of a support at 44 consisting of, in this case, a pair of spaced, vertically extending upright members 46, 48. The upright members 46, 48 could be made of lumber, metal, or any suitable material known to those skilled in the art, and are each suitably anchored in conventional fashion relative to a support surface 50. The upright members 46,48 cooperatively carry a display system/panel 52 having a flat display surface 54 upon which information 56 pertaining to the public right-of-way is applied. The information can be the identification of an exit, identification of a highway number, a distance designation, or virtually any type of information that is commonly provided on signage on federal and state highways to aid the navigation of vehicles. Lights 58 are provided on the support 44 to illuminate the information 56 on the display surface 54. The plane of the flat display surface 54 is aligned normally at substantially a right angle to the length of the lanes 12, 14 so as to be readily viewable by an occupant from a vehicle, moving in the direction of the arrow 16 in the lanes 12, 14.

It is conventional for the sign system 30 that there is no signage or other ornamentation on the side 60 of the sign system 30 opposite to the display surface 54. Thus, the side 60 performs no function, and in a worst case, may produce an unsightly structure to those traveling in the opposite lanes 18, 20.

According to the invention, information, shown generically at 62, is provided on the side 60 of the sign system 30. The information 62 is preferably at least in part unrelated to the public right-of-way. The information 62 may be advertising information placed by individuals or companies relating to a location to which access can be gained via the right-of-way 10 or just general advertising material with no connection to the right-of-way 10.

The information 62 can be applied directly to the back side structure shown in FIG. 3 or, more preferably, a separate display system/panel 64 can be carried by the support 44 and mounted to the upright members 46, 48 so that a flat display surface 66 thereon faces oppositely to the display surface 54.

Optional lights 68 may be provided to illuminate the information 62 on the display surface 66. Alternatively, the information 62, in this embodiment and the others described herein, can be defined by lights, which generates fixed, or variable information.

The sign system 38 may be exactly the same as the sign system 30, but in a reverse orientation so that the information 56 is readily viewable by occupants from vehicles traveling in the lanes 18, 20 in the direction of the arrow 22, with the information 62 viewable from vehicles traveling in the lanes 12, 14 in the direction of the arrow 16. The sign system 38 can be provided with or without illumination.

The sign system 30 is spaced sideways fully from the lanes 12, 14 on the side opposite the lanes 18, 20, with the sign system 38 being spaced sideways from the lanes 18, 20 on the side opposite the lanes 12, 14.

By placing the information 62 on signage, according to the invention, many opportunities present themselves. First of all, an opportunity arises to make conveniently available to individuals traveling along the right-of-way 10 advertising information that may be of general interest or usable in traveling along the right-of-way 10. By reason of the close proximity of the information to the lanes 12, 14, 18, 20, viewing can be safely carried out. The traveler is allowed to view general advertising information without diverting attention to the more distant conventional sign systems 40, 42, located commonly on private property.

In some locations, billboards are prohibited off the right-of-way. Thus, the invention affords an opportunity for businesses in these areas to advertise, thereby providing a boost to local economics.

Further, signage on the right-of-way may provide critical emergency information to a motorist which would not otherwise be available in locations where billboards are banned.

At the same time, the sign systems 30, 38 present additional sources of income for the federal or state authority that regulates and maintains the right-of-way 10. That particular body can assess fees for the use of space, as well as additional fees for maintenance and/or changing of the sign systems 30, 38, which can be carried out conveniently in conjunction with the normal sign system maintenance.

Significantly, the provision of the advertising space within the right-of-way 10 obviates the need for the sign systems 40,42 on private property. With proper controls, the regions adjacent to the right-of-way 10 may have an improved appearance. This, in turn, could lead to the ability to demand higher property taxes for the adjacent lands, offering another source of income to the body that taxes the adjoining lands.

The other sign systems 28, 32-36 will be described to show alternative supports for panels bearing information commonly used on right-of-ways 10. It should be understood that the invention is not limited to any of the specific supports shown.

The sign system 28 has a support 69 with an anchoring base 70 and an upright column/section 72 on the base 70 to which a cantilevered arm section 74 is attached. The arm section 74 may have a series of reinforcing trusses 76 and carries a display system/panel 78 with a substantially flat display surface 80 facing the traffic in the lanes 12, 14 moving in the direction of the arrow 16. Lights 82 are provided to illuminate the display surface 80. The cantilevered arm section 74 spans, in this case, substantially fully across both lanes 12, 14. A lesser extension is also common.

According to the invention, a display system/panel 84 is mounted to the arm section 74 so that a flat display surface 86 faces oppositely to the display surface 80 on the panel 78. In this case, information 56 pertaining to the public right-of-way is provided on the display surface 80, with general advertising information being provided on the display surface 86 on the display system/panel 84. The display systems/panels 78, 84 have the same general shape and dimension so that they effectively block each other from opposite directions to contribute aesthetically to the sign system 28. Optional lights 88 can be provided. Alternatively, lights may be used to define the information, which may have a fixed or variable form.

The sign system 32 consists of a support 89 with anchoring bases 90, 92 at the sides of the lanes 18, 20 and 12, 14, respectively. Upright columns/sections 94, 96 project upwardly from the anchoring bases 90, 92, respectively, and bear a spanning section 98 extending fully between the columns 94, 96 and thus fully across the lanes 12, 14, 18, 20. The spanning section 98 is likewise formed by a trussed arrangement at 100. A display system/panel 102 is provided on one side of the spanning section 98 and has a flat surface 104 facing the traffic moving in the direction of the arrow 16 on which information pertaining to the public right-of-way is applied. On the opposite side of the spanning section 98, a display system/panel 106 is provided and has a flat display surface 108 to which information pertaining to the public right-of-way is applied facing traffic moving in the direction of the arrow 22.

In this embodiment, a panel 110 is provided on the spanning section 98 on the side opposite the display system/panel 102 and has a display surface 112 facing oppositely to the display surface 104 to which general advertising information is applied. Similarly, a display system/panel 114 is mounted to the spanning section 98 on the side opposite the panel 106 and has a flat display surface 116 facing oppositely to the surface 108 and to which general advertising material is applied.

In this case, the display systems/panels 106, 114 preferably have the same shape and dimensions, as do the panels 102, 110. Lights 118 are provided to illuminate the display surfaces 104, 108, 112, 116 or to define the information in a fixed or variable form.

The sign system 34 consists of a support 119 in the form of an upright to which a display system/panel 120 is secured the support element 119 is anchored in the center median 23, with the sides of the display system/panel 120 projecting to an overlapping relationship with the lanes 14, 18. A flat display surface 122 has information thereon pertaining to the public right-of-way. A display system/panel 124 on the opposite side of the panel 120 has a flat display surface 126 facing oppositely to the display surface 122 and bearing general advertising information.

The sign system 36 is similar to the sign system 34, with the principal difference being that the display systems/panels 128, 130, corresponding to the display systems/panels 120, 124, are of a width to reside entirely within the median 23.

The sign systems 40, 42 are generally the same as the sign systems 30, 38, but may have a larger display surface 132, 134 than that for the sign systems 30, 38, to make the information thereon legible from a greater distance.

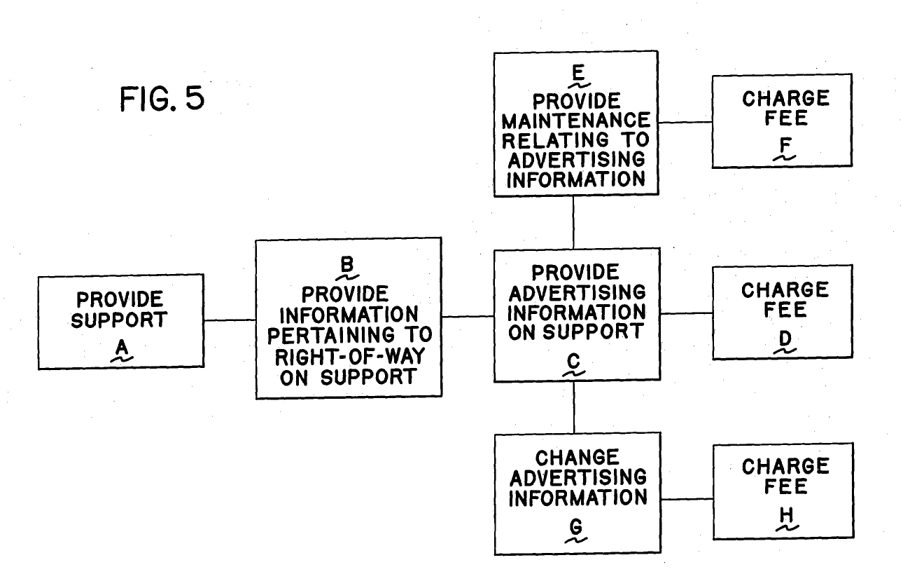

In FIG. 5, the inventive method is depicted in block diagram form. As shown in block A, a support is provided. In block B, information pertaining to the right-of-way is provided on the support. In block C, advertising information is provided on the support. In block D, a fee is charged to allow the advertising information to be maintained on the support. In block E, maintenance is provided relating to the advertising information on the support. In block F, a fee is charged for the maintenance. In block G, the advertising information is changed, for which a fee is charged, as indicated in block H.

Accordingly, at least three opportunities arise to generate ongoing revenue. Revenue can be derived from the initial installation and ongoing “rental” to allow an entity to maintain the advertising information on the support. Since the support and the display system thereon containing the information pertaining to the right-of-way are routinely, periodically maintained, the maintenance can be extended to the display system carrying the advertising information with little added cost. Maintenance may be in the nature of washing the display system or changing bulbs in the event that the display system utilizes light sources to either generate the information or highlight the information. During maintenance of the support and display systems carrying the information pertaining to the right-of-way, personnel can maintain or change the advertising information and charge a separate fee. This maintenance and/or change could be carried out alternatively in a dedicated operation.

Accordingly, there exists the opportunity to raise revenues for the particular agency owning rights with respect to the right-of-way. At the same time, unsightly advertising signage can be removed from locations significantly to the sides of the vehicle lanes, thereby eliminating potentially dangerous distractions to drivers. Aside from improving safety, the relocation of the advertising makes the same more readily viewable so that it becomes more effective.

The foregoing disclosure of specific embodiments is intended to be illustrative of the broad concepts comprehended by the invention.

1. A method of generating revenue from the right to display advertising information on or adjacent to a public right-of-way, the method comprising the steps of:
providing a support on or adjacent to a public right-of-way including at least one lane for vehicle traffic to move in a first direction and a second lane spaced to a side of the one lane for vehicle traffic to move in a second direction oppositely to the first direction;
providing information pertaining to the public right-of-way on the support in a manner that the information is viewable by an occupant of a vehicle in the one lane moving in a first direction and facing generally in the first direction;
providing advertising information unrelated to the public right-of-way on the support so that the advertising information is viewable by an occupant of a vehicle moving in the second direction in one of the lanes and facing in the second direction; and
charging a fee to an entity to allow the advertising information to be maintained on the support by the entity.

2. The method of generating revenue according to claim 1 wherein the step of providing advertising information comprises providing the advertising information on a substantially flat, first display surface facing in the first direction.

3. The method of generating revenue according to claim 2 wherein the step of providing information pertaining to the public right-of-way comprises providing information pertaining to the public right-of-way on a substantially flat, second display surface facing oppositely to the first direction.

4. The method of generating revenue according to claim 1 further comprising the step of illuminating the advertising information.

5. The method of generating revenue according to claim 1 wherein the step of providing information pertaining to the public right-of-way comprises providing information pertaining to the public right-of-way on a first display surface that is on the support in an elevated position and at least partially directly over the one lane.

6. The method of generating revenue according to claim 5 wherein the step of providing a support comprises providing a cantilevered arm projecting across at least part of the one lane with the first display surface on the cantilevered arm.

7. The method of generating revenue according to claim 1 wherein the step of providing a support comprises providing first and second upright sections with one of the upright sections on one side of the one lane opposite to the second lane and the other of the upright sections on the side of the second lane opposite to the one lane and a spanning section between the first and second upright sections and extending fully across both the one and second lanes, and the step of providing advertising information comprises providing advertising information on the spanning section.

8. The method of generating revenue according to claim 1 wherein the step of providing a support comprises providing a support that is fully spaced sideways from both of the lanes.

9. The method of generating revenue according to claim 1 wherein the step of providing information pertaining to the right-of-way comprises providing information pertaining to the right-of-way on a first display surface with a first area on the support, and the step of providing advertising information comprises providing advertising information on a second display surface with a second area on the support so that the first and second areas overlap both sideways and in a vertical direction.

10. The method of generating revenue according to claim 9 wherein the step of providing information pertaining to the right-of-way and advertising information comprises situating the first and second areas so that the second display surface is substantially completely obstructed by the first display surface from the perspective of an occupant of a vehicle in the one lane moving in the first direction.

11. The method of generating revenue according to claim 1 wherein the information pertaining to the right-of-way is provided on a first display system and the advertising information is provided on a second display system and further comprising the steps of providing periodic maintenance to at least one of the support and the first display system, providing periodic maintenance to the second display system in conjunction with the periodic maintenance to the at least one of the support and the first display system, and charging a fee to the entity for the periodic maintenance to the second display system.

12. The method of generating revenue according to claim 1 further comprising the steps of changing the advertising information and charging a fee to the entity for changing the advertising information.

13. A method of generating revenue from the right to display advertising information on or adjacent to a public right-of-way, the method comprising the steps of:
providing a support at or adjacent to a public right-of-way comprising first and second lanes for vehicle traffic to move in one direction and third and fourth lanes to one side of the first and second lanes for vehicle traffic to move in a second direction opposite to the one direction;
providing a first display system on the support and having information thereon pertaining to the public right-of-way and viewable from a first vantage point;
providing a second display system on the support and having advertising information thereon that is substantially unviewable from the first vantage point and so that the information pertaining to the public right-of-way is viewable from a second vantage point,
wherein the information pertaining to the public right-of-way is viewable by an occupant of a vehicle moving in the one direction in one of the first and second lanes and facing in the one direction,
wherein the advertising information is viewable by an occupant of a vehicle moving oppositely to the one direction in one of the third and fourth lanes and facing oppositely to the one direction; and
charging a fee to an entity to allow the advertising information to be maintained on the support by the entity.

14. The method of generating revenue according to claim 13 wherein there is a center median between the first and second lanes and the third and fourth lanes, and the step of providing the second display system comprises providing the second display system at least partially over the center median.

15. The method of generating revenue according to claim 13 wherein there is a first shoulder region to a side of the first and second lanes opposite to the one side and the step of providing the second display system comprises providing the second display system at least partially directly over the first shoulder region.

16. The method of generating revenue according to claim 13 wherein the step of providing the second display system comprises providing the second display system spaced to one side of the third and fourth lanes and at least partially directly over the first lane.

17. The method of generating revenue according to claim 16 wherein the step of providing the second display system comprises providing the second display system so that the second display system is not directly over either of the third and fourth lanes.

18. The method of generating revenue according to claim 17 wherein the step of providing a support comprises providing a spanning section extending continuously and fully across the first, second, third, and fourth lanes.

19. The method of generating revenue according to claim 13 wherein the steps of providing first and second display systems comprises providing first and second display panels, respectively having the information pertaining to the right-of-way and the advertising information thereon, with substantially the same shape.

20. The method of generating revenue according to claim 19 wherein the step of providing first and second display panels comprises providing first and second display panels having substantially the same size.

21. The method of generating revenue according to claim 13 further comprising the steps of providing periodic maintenance to at least one of the support and the first display system, providing periodic maintenance to the second display system in conjunction with the periodic maintenance to the at least one of the support and the first display system, and charging a fee to the entity for the periodic maintenance to the second display system.

22. The method of generating revenue according to claim 13 further comprising the steps of changing the advertising information and charging a fee to the entity for changing the advertising information.
